(19) United States
(12) Patent Application Publication
(10) Pub. No.: US 2011/0231316 A1
(43) Pub. Date: Sep. 22, 2011

(54) METHOD, SYSTEM AND COMPUTER READABLE MEDIA CONTAINING A PROGRAM FOR IDENTIFYING WHETHER A PRODUCT IS GENUINE

(75) Inventor: John T. CARROLL, III, Columbus, IN (US)

(73) Assignee: CUMMINS INTELLECTUAL PROPERTIES, INC., Minneapolis, MN (US)

(21) Appl. No.: 13/044,376

(22) Filed: Mar. 9, 2011

Related U.S. Application Data
(60) Provisional application No. 61/311,943, filed on Mar. 9, 2010.

(51) Int. Cl. G06Q 10/00; G06Q 40/00

(52) U.S. Cl. 705/44; 705/318

(57) ABSTRACT

Provided herein is a method, system and non-transitory computer readable medium storing instructions related to receiving and storing product code information from plural surveyor surveillance devices and compensating a party associated with each surveyor device that provides information potentially related to a improper transacted sales of a product associated with a gathered product code. The information gathered from the surveillance devices can assist in investigating whether existing products are genuine or counterfeit by identifying non-valid and/or non-registered product codes and improper sales transactions associated with product codes received from the surveillance devices. In an embodiment, a determination is made whether received product code information corresponds to a registered product code stored in a data structure, and for a stored registered product code corresponding to the received product code information, a determination is made of a number of instances the product code information has been received. A party associated with the surveillance device is compensated, or rewarded if the determined number of instances is greater than a predetermined value or the received product code is determined not to correspond to a registered product code.

### RELATED APPLICATIONS

This application claims benefit of priority to Provisional Patent Application No. 61/311,943, filed on Mar. 9, 2010, the entire contents of which are hereby incorporated by reference.

### FIELD OF THE INVENTION

The invention relates to identifying whether a product is genuine using product code information gathered by surveyors.

### BACKGROUND

Fighting counterfeit products, for example, engine and other vehicle parts, can be a priority for business that rely heavily on brand recognition for product sales. Small percentages of lost sales and market share can represent a substantial amount in lost sale revenues. At the same time, businesses are experiencing intense competitive pressure from a large number of organized and unorganized manufacturers and distributors of non-genuine, unauthorized, will-fit, and counterfeit parts. Long standing suppliers also pose price competition by selling replacement parts in the open market that are already at product specifications of genuine parts.

### SUMMARY

The inventions are directed to a method, system and non-transitory computer readable medium storing instructions related to gathering and storing product code information from plural surveyor devices and electronically compensating a party associated with each surveyor devices that provides information determined to identify non-valid product codes and potentially whether any sale of a product associated with a gathered product code was properly transacted.

In an aspect of the disclosure, a method for identifying whether a product is genuine includes receiving product code information associated with a product, which has been transmitted from a surveillance device. The method includes determining whether the received product code information corresponds to a registered product code stored in a data structure, and for a stored registered product code corresponding to the received product code information, determining a number of instances the product code information has been received. A party associated with the surveillance device is electronically compensated or rewarded if the determined number of instances is greater than a predetermined value or the received product code is determined not to correspond to a registered product code.

In another aspect of the disclosure, a system for identifying whether a product is genuine includes a code services provider adapted to receive product code information transmitted from a surveillance device. The received product code information is associated with a product and obtained by the surveillance device. The system includes a product code manager adapted to determine whether the received product code information corresponds to a registered product code stored in a data structure, and for a stored registered product code corresponding to the received product code information, determine the number of instances the product code information has been received. A compensation module of the system is adapted to electronically compensate a party associated with the surveillance device if the determined number of instances is greater than a predetermined value or the received product code is determined not to correspond to a registered product code.

In yet another aspect of the disclosure, a non-transitory computer readable medium includes a plurality of instructions which, when executed by a processor, causes the processor to receive product code information transmitted from a surveillance device, where the product code information is associated with a product and obtained by the surveillance device. The instructions cause the processor to determine whether the received product code information corresponds to a registered product code stored in a data structure, and for a stored registered product code corresponding to the received product code information, determine a number of instances the product code information has been received. The instructions also cause the processor to compensate a party associated with the surveillance device if the determined number of instances is greater than a predetermined value or the received product code is determined not to correspond to a registered product code.

Other features, elements, characteristics and advantages of the present invention will become more apparent from the following detailed description of exemplary embodiments of the present invention with reference to the attached drawings.

### BRIEF DESCRIPTION OF THE DRAWINGS

FIGS. 1A and 1B are examples of known bar code standards.

FIG. 2 is a diagram of an exemplary system in which a manufacturer, a code services provider and surveyors communicate information related product codes.

FIG. 3 is a logic diagram of an exemplary code services provider.

FIG. 4 is a diagram of an exemplary process for generating, registering and providing product codes.

FIG. 5 is a diagram of an exemplary process related to a sale of a product and updating information related to the product code of the product.

FIG. 6 is a diagram of an exemplary process related to surveillance of products and compensation of surveyors.

FIG. 7 is a diagram of an exemplary computer system that can be used by the code services provider, the manufacturer, and/or the surveyors.

### DETAILED DESCRIPTION

Many aspects of this disclosure will be described in terms of actions to be performed by elements of a computer system or other hardware capable of executing programmed instructions. It will be recognized that in each of the embodiments consistent with the disclosure, the various actions could be performed by specialized circuits (e.g., discrete logic gates interconnected to perform a specialized function), by program instructions, such as program modules, being executed by one or more processors (e.g., a central processing unit (CPU) or microprocessor), or by a combination of both. Logic of embodiments consistent with the disclosure can be implemented with any type of appropriate hardware and/or software, with portions residing in the form of computer readable storage media with a control algorithm recorded thereon such as the executable logic and instructions disclosed herein, and can be programmed, for example, to include one or more look-up tables and/or calibration parameters. The program instructions can be stored on any non-transitory computer readable medium, which can comprise a random access memory (RAM), a read-only memory (ROM), an erasable programmable read-only memory (EPROM or Flash memory), an optical fiber, and a portable compact disc read-only memory (CD-ROM), or any other solid-state, magnetic, and/or optical disk medium capable of storing information. Thus, various aspects can be embodied in many different forms, and all such forms are contemplated to be consistent with the disclosure.

In one aspect, a process and system relies on both commercially mature and emerging technologies to label products (i.e., goods or services) at the time of their manufacture or creation such that it is readily possible thereafter to determine whether or not the product is a properly registered product (i.e., genuine) and whether or not any sale of the product was properly transacted.

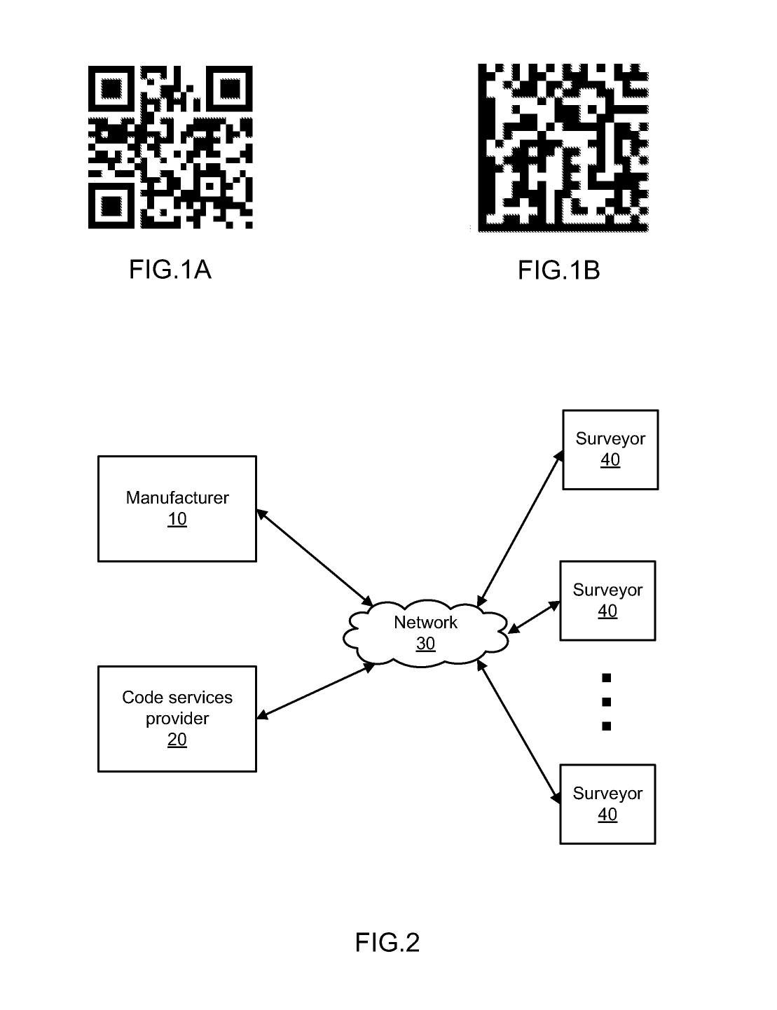

Product information can be provided with a product in a variety of ways. For instance, a label or other indicia containing an optically readable representation of the product's code, such as a commercially available bar code standard, can be attached, marked or otherwise readable from to the product and read using surveillance device, such as an image capturing device or a scanner. For example, a product code can be represented using two-dimensional bar formats such as Quick Response (QR) code and Datamatrix code standards, as shown in FIGS. 1A and 1B, respectively. Additionally, a product code can be unique (i.e., unique to a unit product) and encrypted. Product codes can include product description, manufacturer, manufacturing location, and manufacturing date information and at least one additional alphanumeric string to uniquely identify each instance of a unique product (goods or service) family. Processes and interfaces used to generate, store, and transmit product codes can be securely maintained to ensure the integrity of each product code in use. For example, product codes can be securely stored in one or more central or distributed product code databases. Each product code database can facilitate cross referencing product description and manufacturing information captured in the product code. The product code database can further facilitate storage and cross referencing of product code status information comprising at least a logical status of whether (TRUE) or not (FALSE) each available product code has been registered (i.e., assigned to or associated with a product) and a count status of the number of times a sale involving a particular product code was transacted or the product was reported by a surveillance facilitator post sale.

As will become apparent from the description herein, embodiments consistent with the disclosed process, system and non-transitory computer medium containing a program product can facilitate both proactive and reactive discouragements to unauthorized manufacture, distribution, and sale of branded products, as follows:

1. Would-be counterfeiters would need to apply a product code label to their products to pass a casual visual test of legitimacy since all branded products would bear a product code label.

2. In the case that a would-be counterfeiter would simply duplicate a valid and registered product code label, pre- and post-sale surveillance efforts by the product owner, any of a branded product's stakeholders (e.g., manufacturers, distributors, service centers, end customers, contract brand enforcers, and law enforcement agencies), and/or electronically compensated freelance surveyors operating surveillance devices would cause a suspicious number of transacted sales or other reported sightings to be counted and flagged for further investigation.

3. In the case that a would-be counterfeiter would be inclined to generate a series of product code labels, they would be discouraged by not having knowledge of the necessary product code components and encryption technique, nor access to the product code registration system to properly register codes. Product code labels generated without the necessary knowledge and insights just mentioned would be readily discovered as counterfeits by surveillance specialists and/or program applications analyzing data gathered by stakeholders and freelance surveyors.

4. Increasingly available, capable, and affordable camera-equipped cell phone and smart phone technologies can enable professionals and freelancers to easily gather and transmit valuable surveillance data. Further, these devices and other existing technologies can make it possible to recover location information such as a Geographic Positioning System (GPS) location, when authorized, and to incentivize freelancers by way of compensating them, such as electronically applying credits to their cell phone accounts, bank accounts, provide offers or coupons, or crediting some other account associated with the authorized party.

Some existing anti-counterfeit solutions rely on product labeling and packaging that is intentionally made difficult to duplicate and therefore readily recognizable as counterfeit when it is missing or otherwise does not appear to be authentic. The process, system and program product disclosed herein distinguishes from such solutions in that uniqueness of product labeling is maintained within a secure database and enforced with data that can be gathered by a veritable army of appropriately motivated surveyors equipped with surveillance devices, such as personal cell phones, personal computers, hand-held scanners or other communication device, which are capable of capturing and transmitting product code information to a product code receiving system for analysis. Motivation can be in the form of compensation, for example, if the analysis determines that the received code is of some value in a determination of authenticity of the product associated with the received product code.

As pointed out above, embodiments of the disclosure can utilize both commercially mature and emerging technologies to label products at or around the time of their manufacture, such that it is readily possible thereafter to determine whether the product is a properly registered product, that is, the product is determined to be associated in a secure memory with a product code, and whether any sale of the product was properly transacted. Further, although details of a process, system and non-transitory computer readable medium containing a program product will sometimes be described from the perspective of goods, such as a part or component, a manufacture of a part or component, point of sale of the part or component, and surveillance of the part or component, it will be apparent that concepts described herein also can readily be applied to embodiments of a process, system and non-transitory computer readable medium containing a program product that relate to one or more service.

FIG. 2 provides an overview of a system from which to introduce additional detail of exemplary embodiments. As shown in FIG. 2, a manufacturer 10 produces products (i.e., goods and/or services) that are provided to a distributors, retailers, wholesalers, or another entity in the supply chain, and either directly or indirectly to consumers. The manufacturer 10 marks each produced product with a product code prior to, but no later than the time of providing that product in a sale to a consumer. The product codes are provided to the manufacturer 10 upon request to a code services provider 20 via a network 30, which can be any one of, or combination of an IP network, an intranet network, a cellular network, a WAN and a LAN. Preferably, communication channels between the manufacturer 10 and the code services provider 20 are secure, for example, using SSL (Secure Socket Layer) or TLS (Transport Layer Security) encryption. The code services provider 20 is capable of generating product codes, storing and updating information related to the product codes, and analyzing received information related to product codes. It is to be understood that while the and code service provider appear as an element of the system separate from the manufacturer 10, such as a third party service provider, a code service provider can be part of a common business entity at a same or different location from a manufacturer.

FIG. 2 also shows plural surveyors 40 connected to the network 30. The surveyors 40 can include stakeholders, end consumers (customers) of the product, or freelance parties that are motivated to perform checks of product codes they encounter in return for possible compensation for their efforts. As will be described later in detail, a freelance surveyor 40 can participate in a surveillance program of the code services provider 20 or the manufacturer 10 and be compensated for providing product code information of some value, or potential value to counterfeit detection.

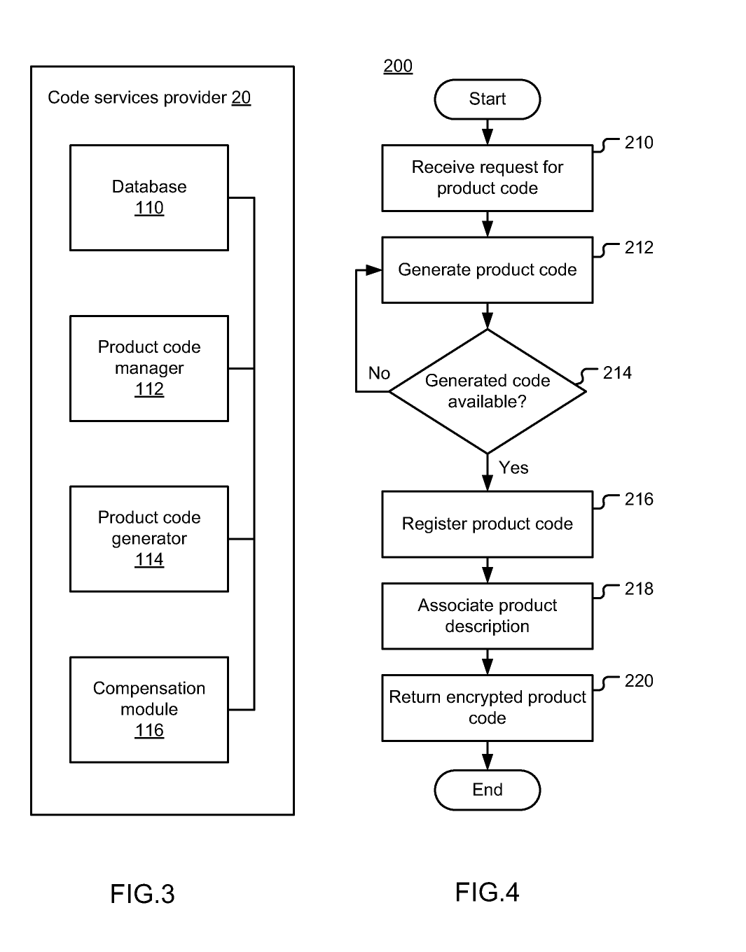

FIG. 3 shows a more detailed diagram of elements of the exemplary code services provider 20. As shown in FIG. 3, the code services provider 20 includes a database 110 that stores product codes and information associated with the product codes. The database 110 can be a single database memory or distributed across several memory devices. A product code manager 112 includes logic for carrying out requests it receives from product manufacturers 10 (or creators) for product codes and product code information gathered and transmitted by surveyors 40. While not shown in FIG. 3, the product code manager 112 can have access to an interface module configured to receive the requests for product codes, for example, from the manufacturer 10, and to receive transmitted product code information from surveyors 40 via a surveillance device. Additionally, the code services provider 20 can include an encryption/decryption module (not shown) for encrypting outgoing product code information and decrypting product code information received from manufacturers, stakeholders consumers and surveyors. The code services provider 20 includes a product code generator 114 configured to generate a product code upon instruction from the product code manager. The product code manager 112 also determines whether product code information received from a surveyor 40 is valuable, that is, useful or potentially useful for determining whether a product is counterfeit, and if it is, it instructs a compensation module 116 to electronically compensate the surveyor 40 for the transmitted valuable product code information.

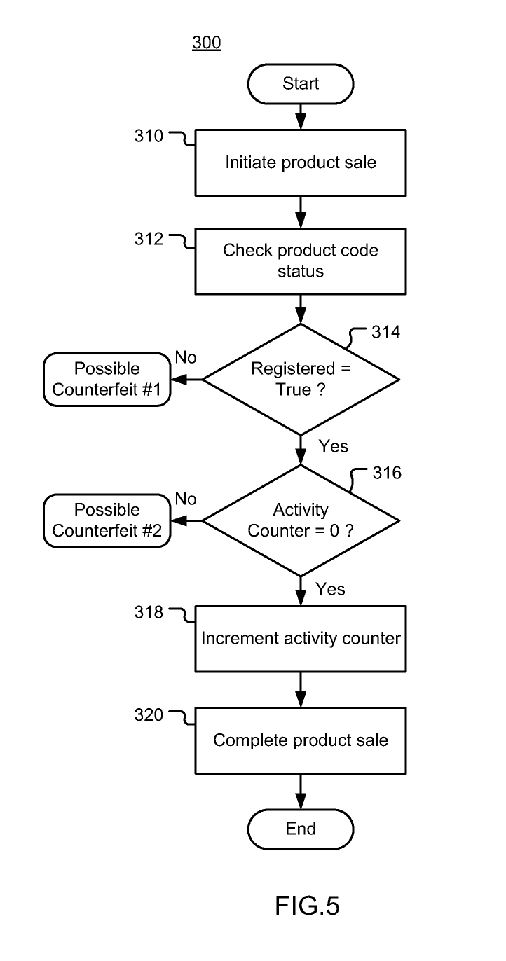

FIG. 4 depicts an exemplary process of manufacture or creation 200 involving generating a product code for a manufactured/created product. In the course of manufacturing or creating a product, a manufacturer/creator makes a request to a code services provider for a product code to associate with the product. In the embodiment depicted in FIG. 2, for example, the manufacturer 10 can request a product code from the code services provider 20 via the network 30, although it is to be understood that the manufacturer 10 can include an application that generates and stores unique product codes and performs the other functions of the code services provider 20 described hereafter.

The process 200 begins and with process 210 in which a product code request is received, for example, by the code services provider 20. After receiving the request, a product code is generated in process 212. In an exemplary embodiment, the code services provider 20 can instruct the product code generator 114 to generate a product code. In an embodiment, the product code generator 114 can utilize product description, manufacturer, manufacturing location, manufacturing date information, and at least one additional string, for example, an alphanumeric string, or other criteria to identify each instance of a product family. The method of generating products codes can introduce some randomness. For example, in the earlier-mentioned alphanumeric string within optional bounds or limits to make that particular ingredient of the product code unpredictable. In decision 214, the generated product code is checked as to whether it is available to avoid possible duplication. For example, the product code manager 112 can check whether the generated product code already exists in the database 110. If the product code is determined not to be available, the “No” path is taken and process 212 repeats.

The product code generator 114 generates valid codes, i.e., a product code has the correct format and content to be properly registered product code (i.e., a code activated for use). The generated valid product code is preferably registered, which occurs if decision 214 determines that the generated product code is available (i.e., the “Yes” path is taken) and process 216 registers the product code. The available product code can be registered using an indication in the database 110, and in process 218 information contributing to the product code and any additional relevant product information is associated with the product code for possible future cross-reference. An exemplary data structure for product codes is shown in Table 1. The registered product code (i.e., the depicted code 999 having the indication “True” for the category “Registered”) can be encrypted and returned, or transmitted to the manufacturer or creator in process 220 to generate and apply a product code label, for example, using a QR, Datamatrix, or another suitable bar coding standard.

TABLE 1

| Product | Product | | Sold/ |
|---|---|---|---|
| Code | Description | Registered | Reported |
| 999 | Abc . . . | TRUE | 1 |

In an embodiment, the process of manufacture or creation 200 can produce a unique product code for each product and can remain encrypted at all times while it is in use outside of the code services provider 20. Would-be counterfeiters would need to apply a product code label to their products to pass a casual visual test of legitimacy since all products and services to be protected (e.g., branded or other proprietary products, product lines and services) would bear a product code, for example, on a label according to the exemplary process disclosed herein. In the case that a would-be counterfeiter simply duplicates a valid and registered product code label, pre- and post-sale surveillance efforts, described later, would generate a suspicious number of transacted sales or other reported sightings to be counted and flagged for further investigation. In the case that a would-be counterfeiter is inclined to generate a series of product code labels, they would be frustrated by not having knowledge of the necessary product code components for a valid product code, the encryption technique used. Product code labels generated without the necessary knowledge and insights just mentioned would be readily discovered as counterfeits through surveillance. Additionally, a would-be counterfeiter would have no access to the secure product code registration system to properly register codes. Thus, even if a counterfeiter were to somehow use a valid code format and content (e.g., by duplicating a valid, registered code), the process of registering a product code in a secure environment, such as a secure database, provides a way to readily identify such improper or suspicious product codes.

QR coding and functionally similar bar coding standards provide opportunities for encrypted forms of product codes to be read using commercially available camera equipped cell phones and dedicated scanners, and to be automatically forwarded to a code services provider to have various product code status checks and updates performed and reported on. These checks and updates will be described hereafter.

FIG. 5 is a diagram of an exemplary process 300 related to tracking the sale of a product and/or service and detecting possible instances of counterfeit products. Process 300 starts at the point of initiating a product sale, as shown in process 310. Next, process 312 verifies the physical presence of a product code and checks its status by way of secure communication with the code services provider 20. All valid product codes can exist within the database 110 of code services provider 20 and can additionally be registered (i.e., “True” for the registered status). Decision 314 determines whether the status of the product code indicated it is registered. In cases where a product code cannot be verified and/or verified product codes are not registered, possible counterfeit (i.e., the “No” path to “counterfeit #1”) would be indicated and further investigation would be suggested or initiated. The process of tracking the sale of a product thus far described would provide opportunities to capture the rich context of the transaction (e.g., seller details including geographic location) to facilitate further investigation. In cases in which product codes can be verified and verified product codes are registered, the “Yes” path is taken to decision 316, which determines whether the activity counter is equal to zero (i.e., no stored indication that the product has been subject to sale or reported, for example, by a surveyor). If the activity counter is determined to be greater than zero, possible counterfeit (i.e., the “No” path to “counterfeit #2”) would be indicated, and further investigation would be suggested or initiated. If the activity counter associated with the product code is equal to zero, process 318 increments a counter associated with the product code by one (1), and the product sale completes at process 320. The activity counter can provide a way and mechanism to detect circulation of duplicate product codes, and thereby generate an indication of suspicion that one or more of these products is counterfeit.

In an embodiment, the proposed product code labeling described above can replace existing UPC format bar code labeling and that the above-described checks would be automated to be a transparent part of normal product sale transactions.

As described above, surveillance can be carried out both pre- and post-sale in one or more of a variety of circumstances (e.g., service events, trade shows, truck stops, counterfeit raids, customs inspections, and warehouses to name a few), and one or more persons, for example, individuals permanently or temporarily employed by brand owner, law enforcement officials, distribution channel stakeholders, and end customers to name a few. However, it is to be appreciated that products will not always be sold in such a way that it is convenient or possible to increment an activity counter associated with a product code in the database 110. Also, most often it will not be economical to employ sufficient numbers of dedicated surveillance personnel to present an adequate deterrent to counterfeit. To address these problems, an embodiment enlists or encourages anyone possessing basic tools to read and transmit a product code, such as a product code label or other indicia, to assist in surveillance efforts and potentially be rewarded for their efforts. For example, freelance persons can be rewarded for helping to spot check product codes when and where they encounter them. Such persons can be rewarded if it is determined that the product code information transmitted from the surveillance device does not corresponds to a valid product code, does not correspond to a registered product code, or if it is determined that the activity count value associated with transmitted product code information is greater than a predetermined value, for example, greater than one. No rewards would be paid for counts incremented during the processing of normal sales. In an embodiment, rewards can be paid by crediting the caller's cell phone account. A reward amount can be set to reflect the cost benefit tradeoffs of avoiding counterfeit losses.

In general, this aspect of the disclosed process, system and non-transitory computer readable medium takes advantage of increasingly available, capable, and affordable camera equipped cell phone technologies and dedicated product labeling scanners used as surveillance devices alone or in conjunction with cell phone technologies, networked computers, or any other communication device capable of facilitating gathering and processing of product codes and communicating product code information to a code service provider, and motivation of the freelance individuals provided by compensation for successfully carrying out surveillance of product codes. As shown in FIG. 3, the exemplary code service provider 20 includes a compensation module 116 that electronically compensates or rewards surveyors 40 that provide valuable or potentially valuable information for counterfeit detection, for example, as determined by the product code manager 112. The compensation module 116 can process electronic compensation to the freelance surveyor in any of a number of predetermined ways. For example, a freelance surveyor can enter into an agreement with the manufacturer/creator that provides for electronically crediting the surveyor's phone account, directly and electronically depositing funds into an account indicated by the surveyor, electronically providing a credit amount to the surveyor towards a future purchase, or another predetermined compensation scheme.

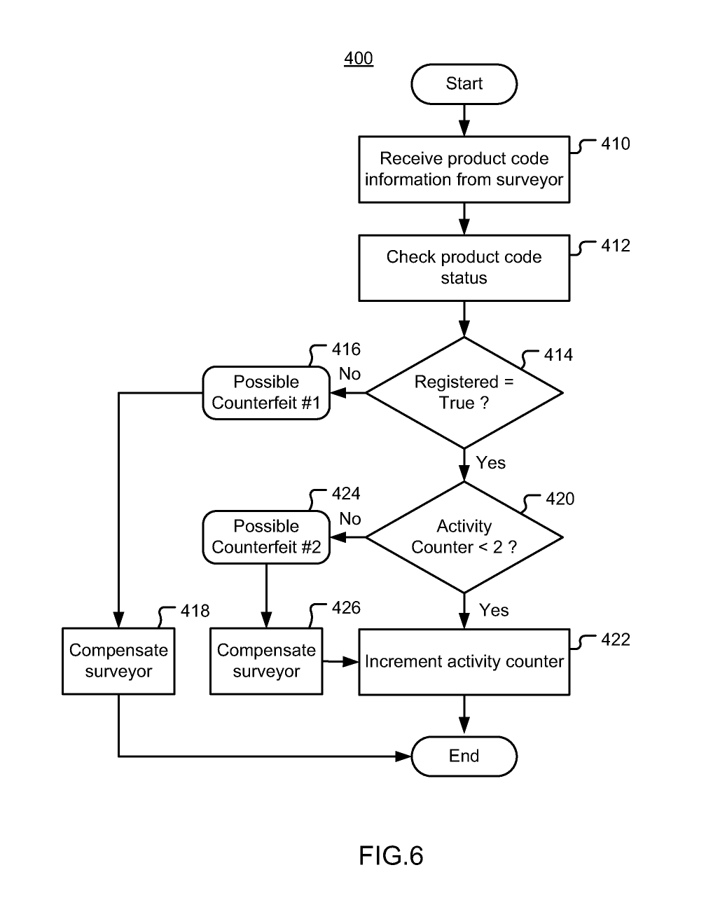

FIG. 6 is a diagram of a surveillance process 400 according to an exemplary embodiment that involves reading and decoding a product code, for example a product code captured from a label, by at least one surveyor's surveillance device. The surveillance process 400 can be carried out by a module of the code services provider 20, such as the product code manager 112. The process 400 begins at process 410, where the code services provider 20 receives product code information transmitted by a surveillance device, such as a camera-equipped cell phone of the surveyor. In process 412, the code services provider 20 checks the product code status to verify the physical presence of a product code in the database 110, and/or to determine a status of registration of the product code (e.g., “True” for registered and “False” for not registered). At decision 414, it is determined whether the received product code is registered. If the product code is determined not to be registered (i.e., it is not activated), it is flagged for further investigation at process 416 as associated with possible counterfeit product (i.e., the “No” path to “counterfeit #1”). Additional surveillance devices can further confirm counterfeit status of products associated with that same product code. A surveyor is compensated, at process 418, for reporting product code information that can be used to determine that the transmitted product code information has no stored corresponding registered product code, and thereafter process 400 ends.

If decision 414 determines that a received product code is registered, the “Yes” path is taken to decision 420 where a determination is made with regard to an accumulated value of an activity counter. More specifically, process 420 identifies each instance of an accumulated activity count value in excess of a predetermined value (e.g., in excess of one (1)) as an indication that duplicate product codes are likely in use, and thus suggest possible counterfeit activity. If the activity count is greater than the predetermined value, the “No” path is taken and the transmitted product code is flagged for further investigation at process 422 (“possible counterfeit #2”). However, because an activity count can flagged in a situation where a particular product has been repeatedly considered, the code services provider can keep a record of the surveyor's ID along with each report to prevent the same surveyor from repeatedly scanning the product code. Another possible scenario to consider is that products bearing duplicate labeling might be scanned by one or more surveyors. Without additional information, such a scenario can be indistinguishable from a scenario where a single product might be scanned multiple times by one or more surveyors. To better resolve the circumstances of any or all of such scenarios, additional information can be gathered by the code services provider. For example, a cell phone IMEI number, a cell provider, geographical position, calendar date, and time of day etc. can be obtained and used to analyze and distinguish between different instances of these codes among plural copies of a same product codes. Also, the surveyor need not be notified at the time of scanning that that scan resulted in compensation to reduce any occurrence of a surveyor notifying another surveyor of a particular product code that resulted in compensation. In an embodiment, an activity counter having an accumulated activity count values of zero (0) indicates a case in which surveillance is performed pre-sale, and a value of one (1) can indicates a case in which surveillance is performed post-sale. In these cases (“0” or “1”), the “Yes” path is taken from decision 420 to process 422, which increments the activity counter, and thereafter process 400 ends.

If decision 420 determines the activity counter value is greater than two (2), the transmitted product code information is considered as possible valuable information and the “no” path is taken to process 424 to flag the product code (and the associated product) as possible counterfeits (i.e., “possible counterfeit #2”), and at process 426 the surveyor is compensated for capturing and transmitting the product code information before incrementing the activity counter and ending the process 400. As pointed out above, activity counts in excess of one (1) will serve as an indication that duplicate product codes may be in use, and thus suggest counterfeiting activity, or may simply indicate that a particular product has been repeatedly considered by multiple surveyors. This latter scenario can be avoided by exercising care in checking product to make note of or otherwise mark product as having been already checked.

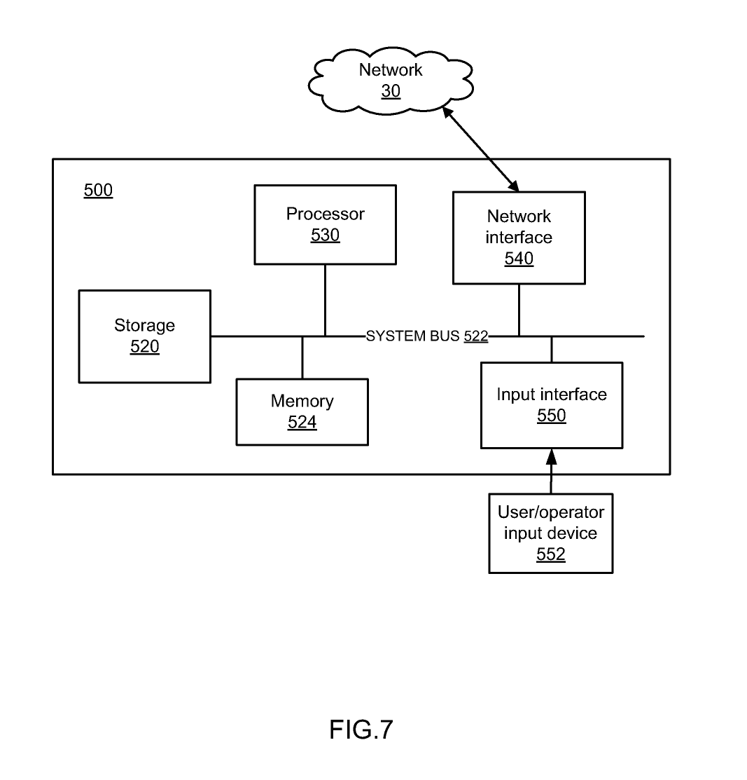

FIG. 7 is a diagram showing components of an exemplary computer system 500, which can be used to implement the code services provider 20, manufacturer 10, surveyor 40, and other network components of the system disclosed herein. In an embodiment, the computer system 500 can be a server and/or a client device located at a network node. The computer system 500 may include storage 520, memory 524, a processor 530 (e.g., a CPU, microprocessor, ASIC or other processor device), a system bus 522 that couples the computer system components to the processor 530, a network interface 540, and an input interface 550. While not shown, the computer system 500 can also include additional components, such as a camera or other image capturing device and a display, such as in the case of a surveillance device of the surveyor 40. The storage 520 is typically non-volatile (i.e., persistent) computer storage media that may include, but is not limited to, magnetic disk storage, magnetic cassettes, magnetic tape or other magnetic storage devices, ROM, CD-ROM, digital versatile disks (DVD) or other optical disk storage, EPROM, EEPROM flash memory and/or any other medium which may be used to store information and which may accessed by components of the computer system 500. In an embodiment, the storage 520 comprises the database 110. Memory 524 is typically volatile memory located on or near the processor (e.g., on the processor board) and may replicate all or parts of the data and/or program modules stored in non-volatile memory to enable fast memory access. Volatile memory includes, but is not limited to RAM, static RAM (SRAM), or other volatile memory technology. The storage 520 and or memory 524 may include data and/or program modules that are executable by the processor 530. If the computer system 500 is part of a distributive processing environment, storage 520 may include program modules located in local and/or remote computer storage media including memory storage devices.

The network interface 540 can be a network card or adaptor to provide the computer system 500 a way to connect and communicate over the network 30, for example, a LAN. Alternatively, the computer system 500 can include a router and/or modem to connect to network 30, for example, if the network were an IP-based WAN, through the network interface 540 and a router, or through an internally or externally provided modem (not shown). In the case of a wireless device, such as a smart phone, the network interface can include signal generator and a transceiver that communicate with a cellular network, an IP network access point, or other network access device via any of a number of known wireless protocols.

The input interface 550, which may or may not be included with one of the computer systems 500 in the network 30, allows users or operators to interact with the computer system 500 through a user input device 552. In some embodiments, user/operator input devices may include a keyboard, mouse or other pointing device, a microphone, a touch display screen, or other activation or known input devices.

Much flexibility can be provided for interaction between a surveyor assisting with surveillance and the code services provider depending on the technology used to capture and transmit product code information, for example, the type of cell phone technology employed to read and transmit product codes and to receive instructions. Possibilities could include, for example, any of the following: basic phone conversation, text messaging, email, touch pad aided dialog, and automated script processing. A hotline, Web site (or at least a central contact) for the field can be created to receive reports of suspected counterfeit products.

Customers and other stakeholders in the customer's life-cycle product experience require timely, convenient, and reliable access to a great variety of information to support productive product purchase, ownership, operation, maintenance, service, and final disposition. In view of this, another aspect of this disclosure relates uniform product labeling that can offer greater functionality to capture key product identification information and to aid customers in obtaining additional information they are seeking related to purchasing, owning, operating, maintaining, servicing, and disposing products. Currently, a data plate is often used to provide identification and/or other product information of a product. Current data plates and other labeling capture key product information that can be used in conjunction with support websites and toll-free assistance services to research and finally retrieve needed information. The current process of retrieving information is a multi-step process that requires customers and other stakeholders in the customer's life-cycle product experience to inconveniently research, transcribe, search, and ultimately recognize the needed information. The process is more time consuming and prone to human error than it need be.

One aspect of the disclosure can, at least in part, involve capturing key product information and customer portal access information using an optically readable code, such as a bar code. For example, key product information and customer portal access information can be provided using a commercially available bar code standard such as the QR code and using the QR code to supplement existing product labeling. The process also can involve this code being functional to quickly, conveniently, and reliably direct customers to sources of needed information. The latter functionality relies on commercially available cell phones equipped with cameras and bar code analysis software to capture and decode bar codes as easily as taking a picture. Bar code standards such as QR can accommodate several hundred characters worth of product data and contact information that can be used to facilitate (even automate) a connection to a central information source to which information can be stored and/or retrieved. Performing surveillance of product codes, ordering a replacement part, ordering a service bulletin and the like can be made as quick, convenient, and reliable as photographing a product bar code, waiting for an automated call to an information center (e.g., a code services provider) to complete, and finally answering a few questions for an automated attendant using the cell phone dial keys.

It is envisioned that access to information using bar codes or other indicia as described here might be additionally restricted using password protected accounts with varying privileges depending on the type of user. For example, an auto parts seller might have access to wholesale pricing information where an end user might instead see manufacture suggested retail pricing. A surveyor, on the other hand, might have access only to information related to one or more successful compensation amounts earned by that surveyor by uploading product code information to a code services provider, for example, according to a predetermined and agreed to manner. An employee of the auto part manufacturer or other privileged or permitted user might additionally have access to a part print, supplier contact information, and relevant engineering standard work. The usefulness and versatility of functional product labeling quickly becomes apparent as one envisions that the product code (e.g., bar code) is a powerful tool in fighting unauthorized manufacture, distribution and sale of branded products and services as well as the only piece of information needed to quickly, conveniently, and reliably retrieve any other piece of information needed to facilitate purchasing, owning, operating, maintaining, servicing, and disposing of the product.

An envisioned extended use of functional labeling would be to allow customers to save maintenance and service history information on information servers for later retrieval. Such service can be offered gratis or for fee. The process, system and non-transitory computer readable medium including a program product described herein, therefore, provide opportunities to more effectively and efficiently monitor and investigate counterfeiters while at the same time support customers with timely, convenient, and reliable access to information related to purchasing, owning, operating, maintaining, servicing, and disposing of products.

Maximizing profits from serving needs of customers largely depends on the ability to offer products and services that provide comparative advantages (i.e., pricing leverage) and to transact sales of these products and services to the fullest extent that markets can support (i.e., volume leverage). While a company can benefit from favorable brand recognition owing to perceived comparative advantages and command substantial market shares, these successes can present increasing challenges to further expand recognition and demand. This is particularly true where both products and markets are mature and where will-fitters, unauthorized reconditioners, and counterfeiters seek to capitalize on the company's successes by directly competing to serve the same market demand. Even small portions of market share lost to counterfeiters, such as organized and unorganized manufacturers and distributors of non-genuine, unauthorized, will-fit, and counterfeit products (goods and/or services) can result in millions in lost sales. Long-standing suppliers also can pose price competition by selling replacement parts that are already at a product owner's specifications in the open market. Therefore, embodiments according to another aspect of the disclosure can discourage customer acceptance of will-fit, reconditioned, and counterfeit product components in favor of genuine (e.g., branded) products, goods and services and provide legal tools to challenge parties who would seek to take from a brand owner's sales opportunities.

Although a limited number of embodiments is described herein, one of ordinary skill in the art will readily recognize that there could be variations to any of these embodiments and those variations would be within the scope of the appended claims. Thus, it will be apparent to those skilled in the art that various changes and modifications can be made to the disclosed process, system and non-transitory computer readable medium without departing from the scope of the appended claims and their equivalents.

What is claimed is:

1. A method for identifying whether a product is genuine, comprising:
receiving product code information transmitted from a surveillance device, said product code information associated with a product and obtained by the surveillance device;
determining whether the received product code information corresponds to a registered product code stored in a data structure;
for a stored registered product code corresponding to the received product code information, determining a number of instances the product code information has been received; and
generating an electronic compensation to a party associated with the surveillance device if either the determined number of instances is greater than a predetermined value or the received product code is determined not to correspond to a registered product code.

2. The method according to claim 1, further comprising accumulating and storing a count value associated with the registered stored product code by incrementing the count value for each instance of receiving the registered product code information up to the predetermined value.

3. The method according to claim 2, further comprising incrementing the count value for each instance of a sales transaction involving the product code.

4. The method according to claim 3, wherein the party is compensated if the accumulated count value reflects more than two said instances.

5. The method according to claim 1, wherein the obtained product code information is encrypted and the method further comprises the step of decrypting the product code information.

6. The method according to claim 1, wherein compensating the party associated with the surveillance device comprises crediting a phone account of the party.

7. The method according to claim 1, wherein the stored registered product code is stored with product description information associated with the product.

8. A system for identifying whether a product is genuine, comprising:
a code services provider adapted to receive product code information transmitted from a surveillance device, said product code information associated with a product and obtained by the surveillance device;
a product code manager adapted to determine whether the received product code information corresponds to a registered product code stored in a data structure, and for a stored registered product code corresponding to the received product code information, determine the number of instances the product code information has been received; and
a compensation module adapted to generate an electronic compensation to a party associated with the surveillance device if either the determined number of instances is greater than a predetermined value or the received product code is determined not to correspond to a registered product code.

9. The system according to claim 8, wherein the product code manager is adapted to accumulate a count value associated with the registered stored product code by incrementing the count value for each instance of receiving the registered product code information up to the predetermined value.

10. The system according to claim 9, wherein the product code manager is adapted to increment the count value for each instance of a sales transaction involving the product code.

11. The system according to claim 9, wherein the compensation module electronically compensates the party if the accumulated count value reflects more than two said instances.

12. The system according to claim 8, wherein the obtained product code information is encrypted and the code services provider further comprises a decryption module adapted to decrypt the product code information.

13. The system according to claim 8, wherein the compensation module is adapted to electronically compensate the party associated with the surveillance device by crediting a phone account of the party.

14. The system according to claim 8, wherein the stored registered product code is stored with product description information associated with the product.

15. A non-transitory computer readable medium comprising a plurality of instructions which, when executed by a processor, cause the processor to:
receive product code information transmitted from a surveillance device, said product code information associated with a product and obtained by the surveillance device;
determine whether the received product code information corresponds to a registered product code stored in a data structure;
for a stored registered product code corresponding to the received product code information, determine a number of instances the product code information has been received; and
compensate a party associated with the surveillance device if either the determined number of instances is greater than a predetermined value or the received product code is determined not to correspond to a registered product code.

16. The non-transitory computer readable medium according to claim 15, wherein the instructions, when executed by the processor, causes the processor to accumulate and store a count value associated with the registered stored product code by incrementing the count value for each instance of receiving the registered product code information up to the predetermined value.

17. The non-transitory computer readable medium according to claim 16, wherein the instructions, when executed by the processor, causes the processor to increment the count value for each instance of a sales transaction involving the product code.

18. The non-transitory computer readable medium according to claim 17, wherein the party compensates the party if the accumulated count value reflects more than two said instances.

19. The non-transitory computer readable medium according to claim 15, wherein the obtained product code information is encrypted and the method further comprises the step of decrypting the product code information.

20. The non-transitory computer readable medium according to claim 15, wherein compensating the party associated with the surveillance device comprises crediting a phone account of the party.

21. The non-transitory computer readable medium according to claim 15, wherein the stored registered product code is stored with product description information associated with the product.
